(19) United States
(12) Patent Application Publication
(10) Pub. No.: US 2018/0065655 A1
(43) Pub. Date: Mar. 8, 2018

(54) COLLAPSIBLE STROLLER HAVING CENTRAL HUB SYSTEM

(71) Applicant: The ERGO Baby Carrier, Inc., Los Angeles, CA (US)

(72) Inventors: Colter P. LEYS, Salt Lake City, UT (US); Alfredo SANTOS, San Francisco, CA (US)

(73) Assignee: The ERGO Baby Carrier, Inc., Los Angeles, CA (US)

(21) Appl. No.: 15/693,868

(22) Filed: Sep. 1, 2017

Related U.S. Application Data
(60) Provisional application No. 62/383,219, filed on Sep. 2, 2016.

(51) Int. Cl. B62B 7/06

(52) U.S. Cl. CPC B62B 7/064

(57) ABSTRACT

A stroller having a central hub system that is reversible and foldable is provided. In one example, support members of the stroller chassis (e.g., members supporting the front wheels, back wheels, handle bar(s), and child seating surface) extend from the central hub system and are selectively rotatable there around. In some examples, the central hub system allows a user to collapse or fold the stroller from a first operational position (e.g., suitable for supporting a child) to a second collapsed position (e.g., where the support members rotate around the central hub system together to a more compact position relative to the operational position). In some examples, the collapsed position may be achieved in a single step (e.g., motion), and by one hand, of the user. The central hub system may also allow for reversing the handlebar to support the child in either a forward or rear facing configuration.

### CROSS-REFERENCE TO RELATED APPLICATION

This application claims priority to U.S. Provisional Patent Application Ser. No. 62/383,219, filed on Sep. 2, 2016, entitled “COLLAPSIBLE STROLLER HAVING CENTRAL HUB SYSTEM,” which is hereby incorporated by reference in its entirety for all purposes.

### FIELD

The present disclosure relates generally to strollers, and more particularly to strollers that are foldable or collapsible when not in use.

### BACKGROUND

Child strollers are well-known in the art. Child strollers generally comprise a chassis, wheels, a handle or handles, and seating for at least one child. For example, standard four wheel strollers are generally useful to transport a single child, and may be designed to accommodate either an infant or a larger child.

Storing child strollers when not in use presents numerous problems, largely because of their large footprint. Accordingly, child strollers are often configured or able to collapse or fold for easy storage in a closet or trunk, for example. Typically, collapsing a stroller may require releasing multiple locking mechanism and manipulating multiple portions of the stroller to collapse or fold the stroller chassis.

### BRIEF SUMMARY

According to one aspect of the present invention, a stroller having a central hub system adapted to allow the stroller to be collapsible or foldable is provided. Further, in some aspects, the central hub system further allows handlebar or seat support to be rotatable relative to the stroller frame for use in a forward or backward facing operational mode. In one particular example, support members of the stroller (e.g., members supporting the front wheels, back wheels, handle bars, and child seating surface) extend from the central hub system and are selectively rotatable there around. In some examples, the central hub system allows a user to collapse or fold the stroller from a first operational position (e.g., suitable for supporting a child) to a collapsed position (e.g., where the support members rotate around the central hub system together to a more compact position relative to the operational position). In some examples, the collapsed position may be achieved in a single step (e.g., motion), and by one hand, of the user. The central hub system may also allow for reversing the handlebar or seat support members to support the child in the first operational position or second operational position, e.g., a forward facing or rear facing configuration.

### BRIEF DESCRIPTION OF THE DRAWINGS

FIG. 1 illustrates a perspective view of a collapsible stroller having a central hub system according to one embodiment of the present invention.

FIGS. 2A and 2B illustrate two exemplary operational mode positions (e.g., forward and backward) of a collapsible strolling having a central hub system.

FIG. 3 illustrates the handlebar moving between the two exemplary operational mode positions.

FIGS. 4 and 5 illustrate an exemplary process for collapsing the stroller from an operational position to the collapsed position.

FIGS. 6 and 7 illustrate an exploded view of a first embodiment of a central hub system for use with a collapsible stroller according to a first embodiment.

FIGS. 8 and 9 illustrate an exploded view of a second embodiment of a central hub system for use with a collapsible stroller according to a second embodiment.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

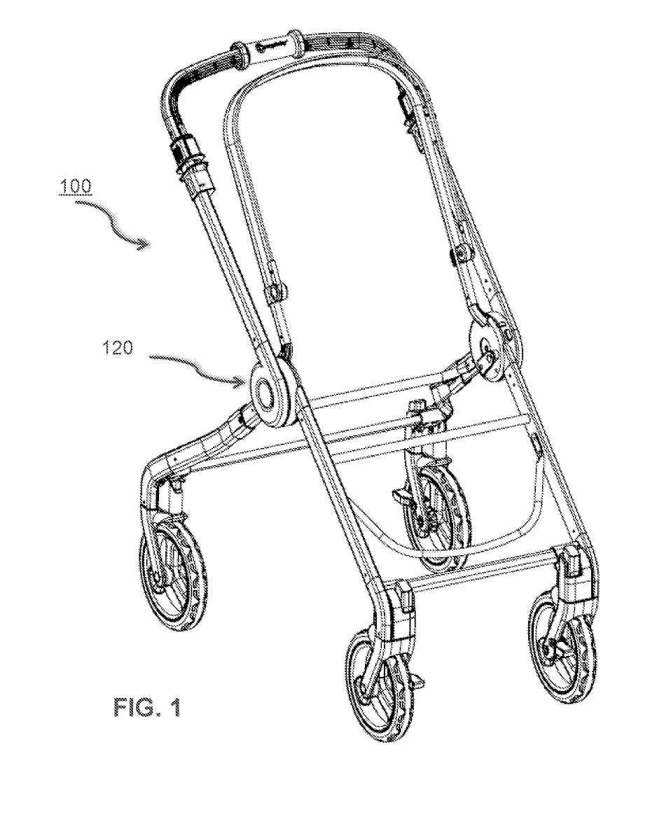

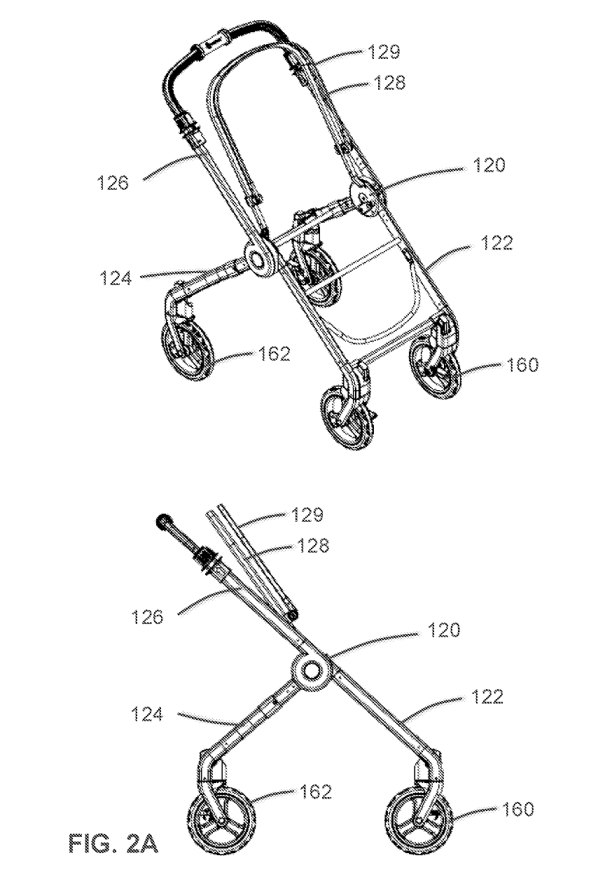

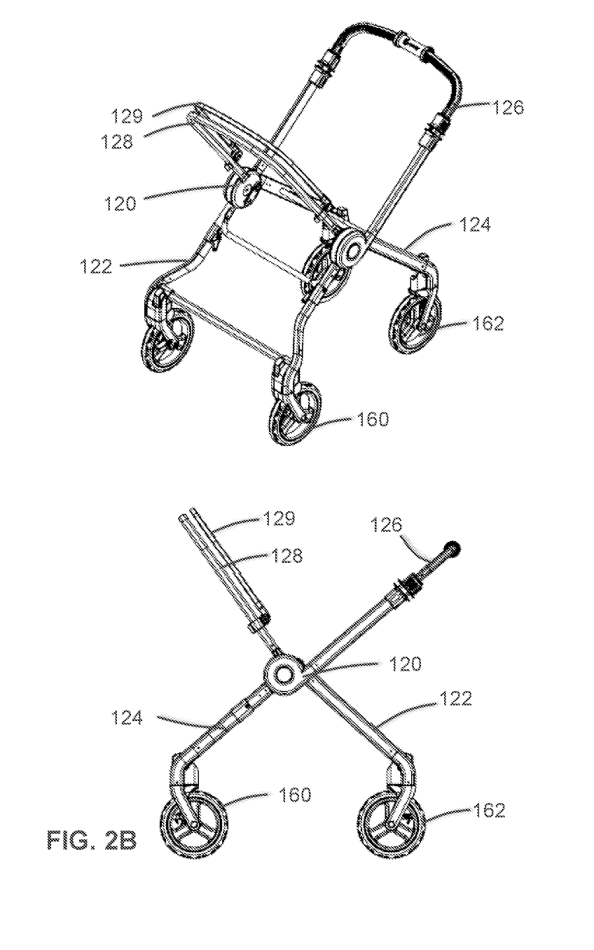

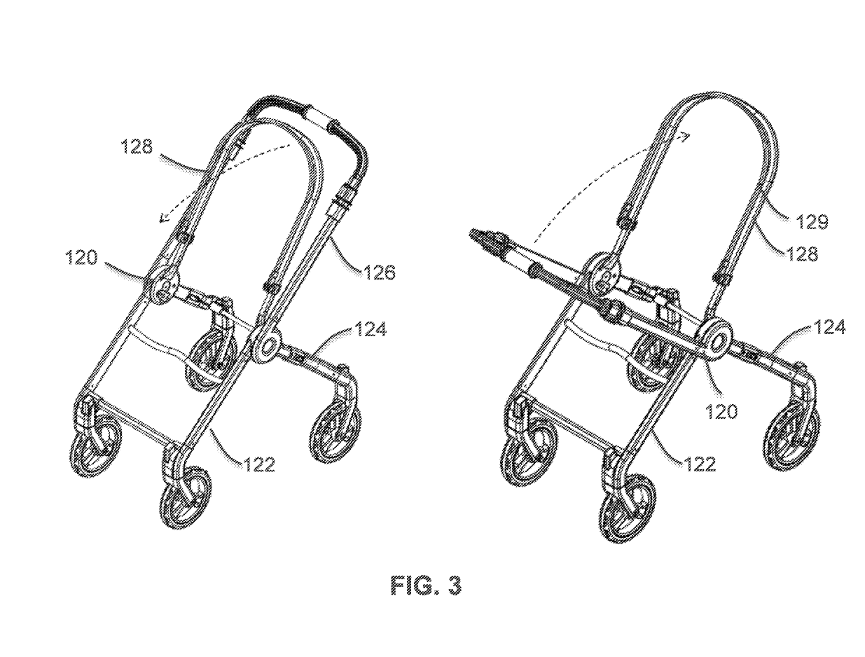

FIG. 1 illustrates a perspective view of a collapsible stroller 100 having a central hub system 120 according to one embodiment of the present invention. As described in greater detail herein (and with reference to in FIGS. 2A-5), central hub system 120 allows a user to collapse stroller 100 into a folded or collapsed position. Further, as seen more clearly in FIGS. 2A, 2B, and 3, exemplary stroller 100 includes two modes of operation, a front facing mode of operation and a rear facing mode of operation, wherein various support members may be selectively positioned for each mode of operation by the user via rotation about central hub system 120. The front facing mode of operation generally refers to a configuration where the child seating surface is oriented so a child will face forward when stroller 100 is pushed (see, e.g., FIG. 2A) and the rear facing mode of operation refers to a configuration where the child will face backward relative to the motion of the stroller when pushed (see, e.g., FIG. 2B).

It is noted that FIG. 1 illustrates exemplary stroller 100 in a front facing mode of operation, but for illustrative purposes the seat itself, as well as various other features that may be included with a stroller have been omitted. For example, a sun or privacy shade, various seating surfaces, safety harness(es), basket(s), cup holder(s), and the like, may be included with the stroller 100.

FIGS. 2A, 2B, and 3 illustrate stroller 100 in the forward facing and rear facing positions (with the seating surfaces removed for illustrating various features). Stroller 100 includes a frame for supporting the seating surface and includes front and back wheel support members 122 and 124, front and back wheels 160 and 162, a handle bar support member 126, and seat support member 128, 129. Notably, the support members 122, 124, 126, and 128 are rotatable about the central hub system 120, and as described below, may be selectively locked into one or more positions.

Further, in some examples, wheel casters 160 and 161 of both the front and back wheels can be selectively locked depending on the usage mode (e.g., forward facing or rear facing). For instance, in a forward facing mode, the front casters can be unlocked and the rear casters locked, and in the rear-facing mode, the front casters locked and the rear casters unlocked. The locking and unlocking of the casters can be activated by rotation of the support members automatically (e.g., via a cable or lever arm linked to the handlebar member 126 and/or the seat support member 128), or manually activated by the user as desired (e.g., via a sliding sleeve, foot activated pin, or other engagement).

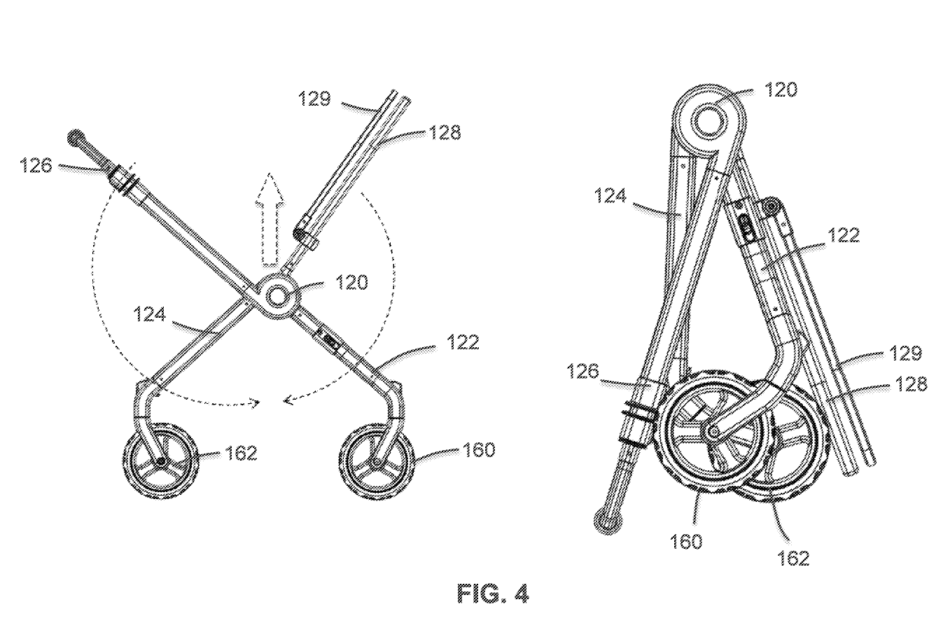

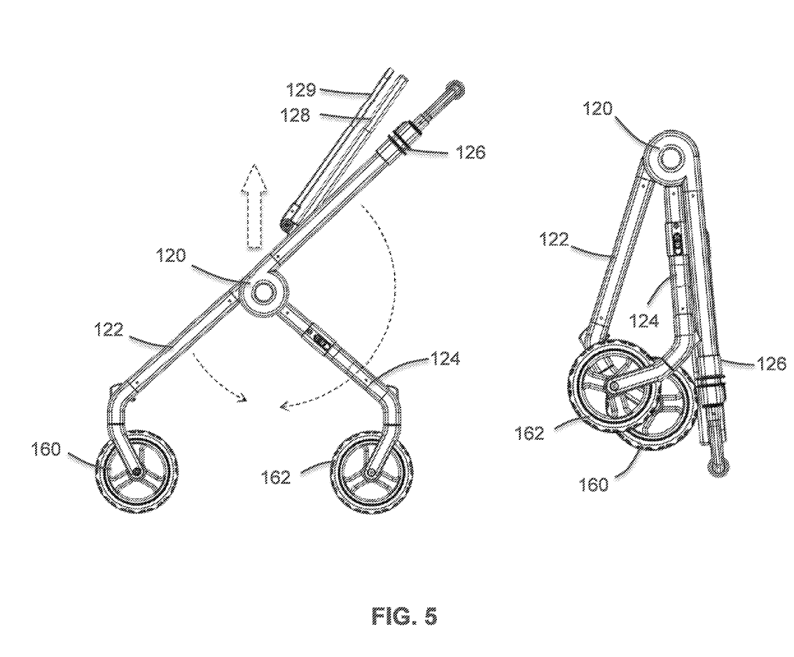

FIGS. 4 and 5 illustrate an exemplary one step process for collapsing stroller 100 from the operational position (either forward facing or rear facing) to the collapsed position. In particular, stroller 100 may be lifted vertically from central hub system 120 to reduce the weight on the wheels and the various support members will rotate downward into the collapsed position in a single step or motion (shown on the right of each figure). For example, as stroller 100 is lifted vertically at central hub system 120, support members 126 and 128 will rotate down toward support members 122 and 124 to the collapsed position in a single step. Further support members 122 and 124 will rotate toward each other into the collapsed position shown in FIG. 5. In some examples, central hub system 120 will need to be unlocked prior to lifting and collapsing to release or allow the support members to rotate. In other examples, the act of lifting central hub system 120 will unlock or release central hub system 120 and allow for rotation of one or more of the support members.

The process for erecting or unfolding stroller 100 into an operational use mode can be achieved by a user placing the wheels on the ground and pushing down on hub system 120 and/or rotating handle bar support member 126 away from the wheel support members 122 and 124. This motion will cause the support members to rotate away from each other and into positions for a use mode.

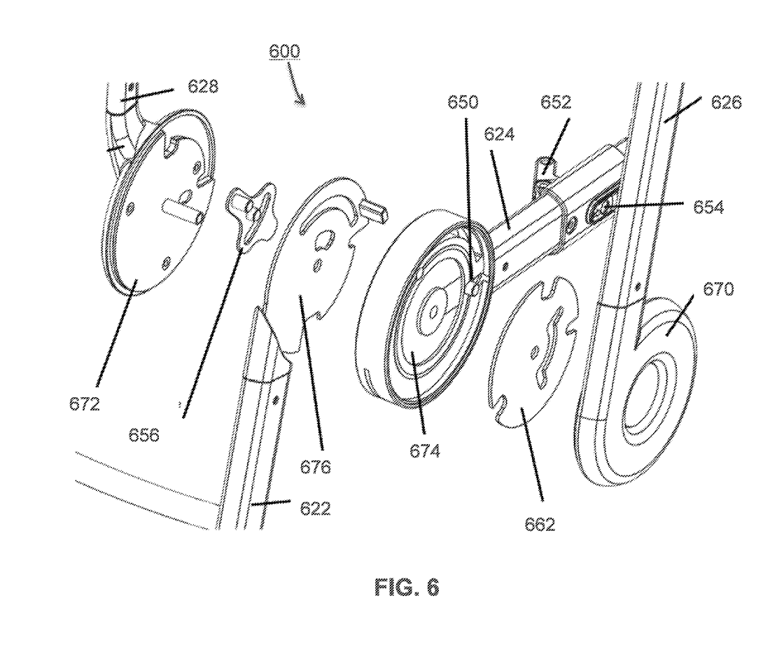

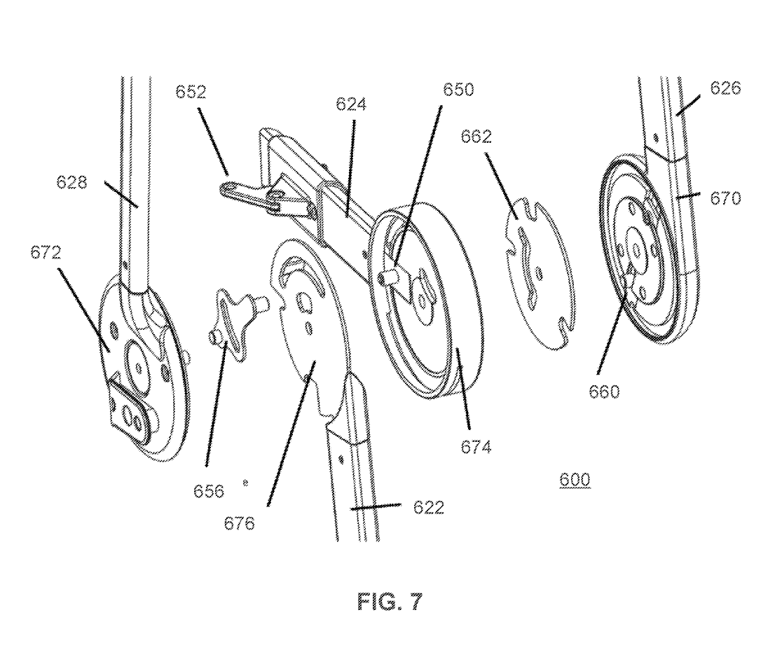

In some examples, central hub system 120 can be configured such that it can only be collapsible (i.e., the wheel support members, seat members, and handle bar members rotate toward each other) when in one of the use positions. For example, stroller 100 can be configured to only be collapsible by a user in the forward facing mode (or alternatively, only in the rear facing mode). This could be achieved via fold release lever (e.g., 652 as illustrated in FIGS. 6 and 7 discussed below) being blocked or inaccessible in one of the two use modes, and or based on locking pins or slots (not shown) included with the support member drive plates that prevent collapsing when in one of the two operational use modes.

Additionally, in some examples, the handlebar support member 126 can be decoupled from the seat support member 128 and the wheel support members 122 and 124. This may allow a user to unfold and lock the wheel support members 122 and 124 and seat support member 126 in place (e.g., into an operational use mode) while or despite a user pushing down on the handlebar support member 128 (e.g., leaning on the handlebar while locking the stroller into an operational use mode). Such a feature may improve the ability to unfold the stroller while the user places some weight on the handlebar support member.

Further, in the above example, stroller 100 is collapsible without incorporating folding joints within any of the support members extending from central hub system 120. That is, all of the folding is achieved through central hub system 120 and the user is not required to fold or collapse any of the support members themselves. This removes complexity and potential locations of instability in the chassis of stroller 100.

FIGS. 6 and 7 illustrate exploded views of a central hub system 600 according to one particular example. In this example, central hub system 600 includes a main locking pin 650 that is selectively activated via a fold release lever 652 for locking or securing support members 622, 626, and 628 (e.g., tubes) in the first operational position and when released, allows the support members to rotate relative to each other to a collapsed position (e.g., as shown in FIGS. 4 and 5 and described above). Central hub system 600 of this example includes a spring-loaded main locking pin 650 that radially locks the support members 622, 626, and 628 in the first operational position and the collapsed position via driving plates and fittings 670, 672, 674, and 676. When selectively activated via a fold release lever 652, the main locking pin 650 retracts radially to allow the support members 622, 626, and 628 to rotate relative to each other to a collapsed position (e.g., as shown in FIGS. 4 and 5). This particular example also includes a fold lock sliding button 654 that when engaged, retracts the main locking pin and allows the support members to rotate towards the first operational position.

In this example, support members 622, 624, and 628, that support the front wheels, back wheels, and child seating surface, are connected through central hub system 600 via a driving plate 656 and a series of slots and pins that allow, when unlocked, for the movement of any one of the three members to drive the motion of the other two. Additionally, when the chassis is being unfolded from the rear facing collapsed position, the front wheel support member 622 engages the handlebar support member 626 during the unfolding motion, which allows all four members to rotate towards the rear facing operational position. The handlebar support member 626 includes a spring-loaded locking pin 660 that when released, radially locks onto the handlebar locking plate 662, which is held in place in the first operational position by the main locking pin 650. The handlebar locking pin can be selectively retracted to allow the handlebar support member 626 to rotate between the rear facing and forward facing positions.

In some examples, the rotation and securement of the support members 622, 624, 626, and/or 628 can be decoupled such that a user can lock different support members into position (e.g., either in a user mode position or collapsed position) at different times. For example, when unfolding a user can rotate and/or lock the wheel support members into place prior to or after locking the handlebar support member into place. These feature can be implemented with locking mechanisms added to one or more support members similar to or identical to the spring-loaded locking pin 660 described above.

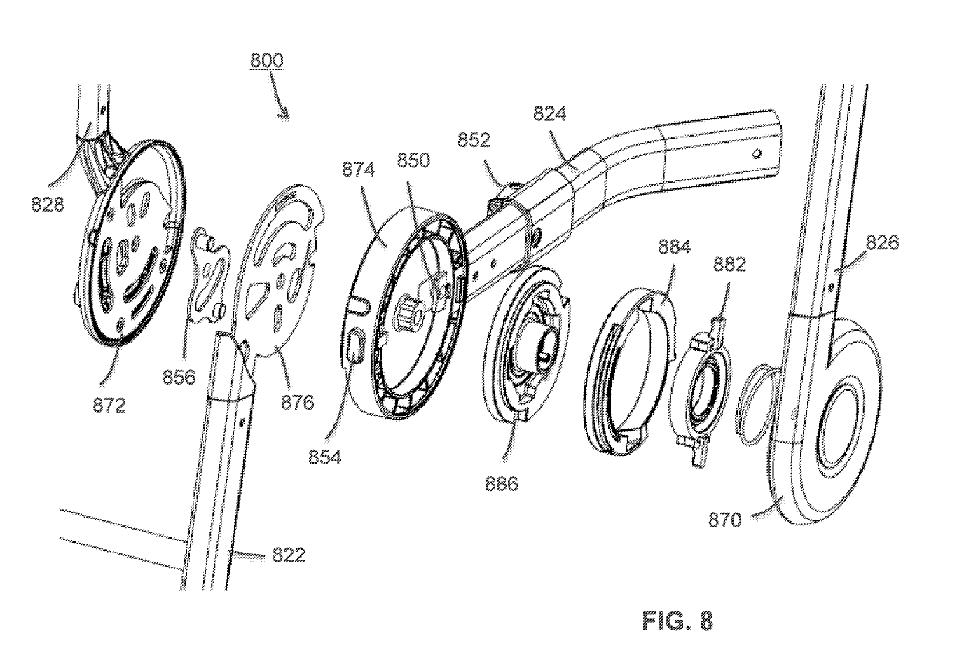

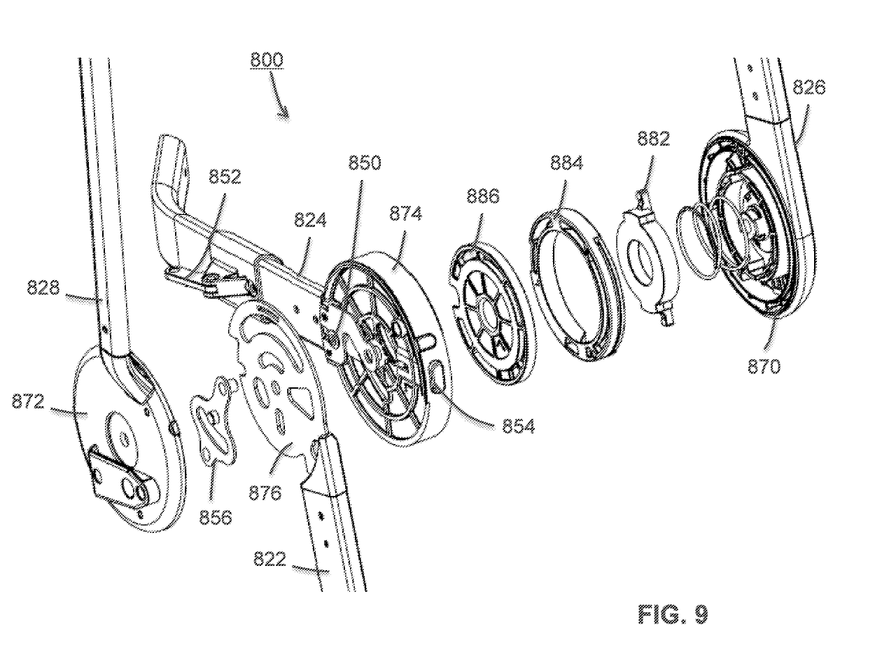

FIGS. 8 and 9 illustrate an exploded view of a central hub system 800 for use with a collapsible stroller according to a second example. In this example, central hub system 800 includes a main locking pin 850 that is selectively activated via a fold release lever 852 for locking or securing support members 822, 826, and 828 in the first operational position and when released, allows the support members to rotate relative to each other to a collapsed position (e.g., as shown in FIGS. 4 and 5 and described above). Central hub system 800 of this example further includes a fold lock and release button 854 located on the central hub 800, which operates to lock the support members in a closed or folded positioned when support members are rotated sufficiently, and when fold lock button 854 is depressed to release or unlock the support members when a user desires to unfold the stroller. When selectively activated via a fold lock button 854 a pin may retract radially to allow the support members 822, 826, and 828 to rotate relative to each other to a use position (e.g., as shown in FIGS. 4 and 5).

In this example, support members 822, 824, and 828, that support the front wheels, back wheels, and child seating surface, are connected through central hub system 800 via a driving plate 856 and a series of slots and pins that allow, when unlocked, for the movement of any one of the three members to drive the motion of the other two via driving plates 876 and fittings 872, and 874. The handlebar support member 826 may further be coupled with central hub 800 via fitting 870 and an actuating ring 882, actuating ring 884, and gear 886, which may further incorporate a handlebar locking mechanism as described above.

It should be understood that the figures herein illustrate a particular example of guiding pins and slot to achieve the desired rotations of the support members, however, other configurations, including gears, geared interfaces, slots, pins, and combinations thereof are possible. The foregoing descriptions of specific embodiments have been presented for purposes of illustration and description. They are not intended to be exhaustive, and it should be understood that many modifications and variations are possible in light of the above teachings. For instance, it should be understood that various combinations of the examples described herein are contemplated.

1. A stroller comprising:
a central hub system, the central hub system supporting:
a front wheel support member;
a rear wheel support member;
a handle bar support member; and
a seat support member, wherein:
the front wheel support member, the rear wheel support member, the handle bar support member, and the seat support member are selectively rotatable around the central hub system from a first operational use mode position to a collapsed position.

2. The stroller of claim 1, wherein the central hub system further comprises a driving plate, a seat support plate coupled to the seat support member, a front wheel support plate coupled to the front wheel support member, and a handlebar plate coupled to the handlebar support member, wherein the driving plate engages the seat support plate, the front wheel support plate, and the handlebar plate to drive rotation thereof together.

3. The stroller of claim 1, further comprising a release, wherein in response to activating the release, the support members are rotatable around the central hub system from the first operational use mode position to the collapsed position.

4. The stroller of claim 3, wherein in response to lifting the stroller vertically at the central hub system the support members rotate from the first operational use mode position toward the collapsed position.

5. The stroller of claim 3, wherein the release is coupled to a locking pin preventing two or more of the support members from rotating.

6. The stroller of claim 1, wherein the support members are rotatable around the central hub system from the first operational use mode position to the collapsed position when the central hub system is lifted vertically.

7. The stroller of claim 1, wherein the support members are rotatable around the central hub system from the first operational use mode position to the collapsed position in a single step.

8. The stroller of claim 1, further comprising a release, wherein the supports members are rotatable around the central hub system in response to activation of the release and lifting the central hub system vertically.

9. The stroller of claim 8, wherein the release is coupled to a locking pin preventing two or more of the support members from rotating.

10. The stroller of claim 1, further comprising a handle bar lock that selectively allows rotation of the handlebar support member relative to the front wheel support member and the rear wheel support member.

11. The stroller of claim 10, wherein the handlebar support member rotates from a forward facing operational use mode position to a rear facing operational use mode position.

12. The stroller 11, wherein the support members are selectively rotatable around the central hub system from either of the first operational use mode position or the second operational use mode position to the collapsed position.

13. The stroller of claim 1, wherein the seat support member is rotatable around the central hub system from the first operational use mode position to a second operational use mode position.

14. The stroller 13, wherein the support members are selectively rotatable around the central hub system from either of the first operational use mode position or the second operational use mode position to the collapsed position.

15. The stroller of claim 1, wherein at least one of the handle bar support member and the seat support member are selectively rotatable around the central hub system from the first operational use mode position to second operational use mode position, and the front wheel support member, the rear wheel support member, the handle bar support member, and the seat support member are selectively rotatable around the central hub system to the collapsed position only from the first operational use mode position.

16. The stroller of claim 1, further comprising a wheel castor coupled to the front wheel support member, and a wheel castor locking mechanism to selective lock rotation of the wheel castor.

17. A central hub system for a stroller, the central hub system comprising:
a front wheel support plate;
a rear wheel support plate;
a handle bar support plate;
a seat support plate; and
a driving plate, wherein:
the front wheel support plate, the rear wheel support plate, the handle bar support plate, and
the seat support plate are selectively rotatable from a first position to a second position.

18. The central hub system of claim 17, further comprising a locking pin, wherein the front wheel support plate, the rear wheel support plate, the handle bar support plate, and the seat support plate are selectively rotatable when the locking pin is disengaged.

19. The central hub system of claim 17, wherein the front wheel support plate, the rear wheel support plate, the handle bar support plate, and the seat support plate are selectively rotatable to support a first operational use mode position and a collapsed position.

20. The central hub system of claim 17, wherein the front wheel support plate, the rear wheel support plate, the handle bar support plate, and the seat support plate are selectively rotatable to support a first operational use mode position, a second operational use mode, and a collapsed position.
